(19) United States
(12) Patent Application Publication
(10) Pub. No.: US 2017/0161958 A1
(43) Pub. Date: Jun. 8, 2017

(54) SYSTEMS AND METHODS FOR OBJECT-BASED AUGMENTED REALITY NAVIGATION GUIDANCE

(71) Applicant: SUPERB REALITY LTD., Tel Aviv, IL (US)

(72) Inventor: Eran EILAT, Beit Shean (IL)

(73) Assignee: SUPERB REALITY LTD., Tel Aviv (IL)

(21) Appl. No.: 15/363,745

(22) Filed: Nov. 29, 2016

Related U.S. Application Data
(60) Provisional application No. 62/261,947, filed on Dec. 2, 2015.

(51) Int. Cl. G06T 19/00; G01C 21/36; B60R 1/00; G02B 27/01; G02B 27/00

(52) U.S. Cl. CPC G06T 19/006; G02B 27/0179; G02B 27/0093; G02B 27/017; B60R 1/00; G01C 21/3676; G02B 2027/0138; G02B 2027/0187; G02B 2027/0178; G02B 2027/0141; B60R 2300/207; B60R 2300/60

(57) ABSTRACT

The disclosure relates to augmented reality assisted navigation. More particularly, the disclosure relates to the use of augmented reality display in providing object-based navigation guidance.

### BACKGROUND

The disclosure is directed to augmented reality assisted navigation. More particularly, the disclosure is directed to the use of augmented reality display in providing object-based navigation guidance.

Augmented reality devices provide an augmented reality environment in which physical objects in a physical space are concurrently displayed with virtual objects in a virtual space. With the help of advanced AR technology, for example, adding computer vision and object recognition, the information about the surrounding real world of the user becomes interactive and digitally usable. Artificial information about the environment and the objects in it can be stored and retrieved as an information layer on top of the real world view.

Conventional route guiding (e.g., navigation guidance or other direction information), provide a route guidance to a destination based on geographical features and objects modeled based on stored geographical information (map information). Meanwhile, an augmented reality (AR) technique is applied such that, when a mobile terminal provides GPS information and/or terrestrial magnetism information to a server, the server determines the location and/or direction of the mobile terminal and provides guide information (AR information) regarding a subject whose images are captured by a camera of the mobile terminal.

In addition, conventional route guiding method (navigation) can have problems since previously obtained and stored contents are provided to a user in advance, subsequent alterations in a street or building cannot be quickly provided to the user, thus failing to provide accurate information to the user, and geographical information periodically updated by a service provider must be downloaded. In addition, in the conventional AR information service, if a location has not been registered to the server, the location cannot be set as a destination, making it difficult to provide direction information to an intended destination.

Accordingly, there is a need for AR-assisted navigation system that will overcome the shortcoming of existing systems.

### SUMMARY

Disclosed, in various embodiments, are methods and systems for using augmented reality display to provide object-based navigation route guidance.

In an embodiment provided herein is an augmented reality device configured to generate an augmented reality (AR) environment comprising an a physical field of view (RFOV) and augmented field of view (AFOV), the augmented reality device comprising; a processor in communication with a non-volatile memory with a processor readable media thereon having a set of executable instructions configured to: determine location of a user; generate the AFOV coincident with the RFOV of the determined location; recognize at least one object representative of a predetermined destination location occurring in the RFOV and augment the RFOV with the at least one object representative of the predetermined destination location occurring in the RFOV, determine an event associated with the augmented reality environment, and generate a subsequent augmented reality environment based on the determined event.

In another embodiment, provided herein is a method for navigating to a predetermined destination in a physical environment comprising: providing an augmented reality device configured to generate an augmented reality (AR) environment comprising an a physical field of view (RFOV) and augmented field of view (AFOV), the augmented reality device comprising; a processor in communication with a non-volatile memory with a processor readable media thereon having a set of executable instructions configured to: determine location of a user; generate the AFOV coincident with the RFOV of the determined location; recognize at least one object representative of a predetermined destination location occurring in the RFOV and augment the RFOV with the at least one object representative of the predetermined destination location occurring in the RFOV, determine an event associated with the augmented reality environment, and generate a subsequent augmented reality environment based on the determined event; and moving towards the object representative of the predetermined destination location.

These and other features of the systems and methods for using augmented reality display in providing object-based rout guidance and navigation will become apparent from the following detailed description when read in conjunction with the figures and examples, which are exemplary, not limiting.

### BRIEF DESCRIPTION OF THE FIGURES

For a better understanding of the systems and methods for using augmented reality display in providing object-based rout guidance and navigation, with regard to the embodiments thereof, reference is made to the accompanying examples and figures, in which:

FIG. 1 shows an embodiment of the systems for using augmented reality display in providing object-based rout guidance and navigation;

FIG. 2 shows the augmented field of view at the commencement of the navigation;

FIG. 3 shows arriving at the designated location;

FIG. 4 shows a flowchart depicting the initial AR assisted navigation process and

FIG. 5 shows a flowchart depicting the AR assisted navigation process.

### DETAILED DESCRIPTION

Provided herein are embodiments of systems and methods for using augmented reality display in providing object-based rout guidance and navigation.

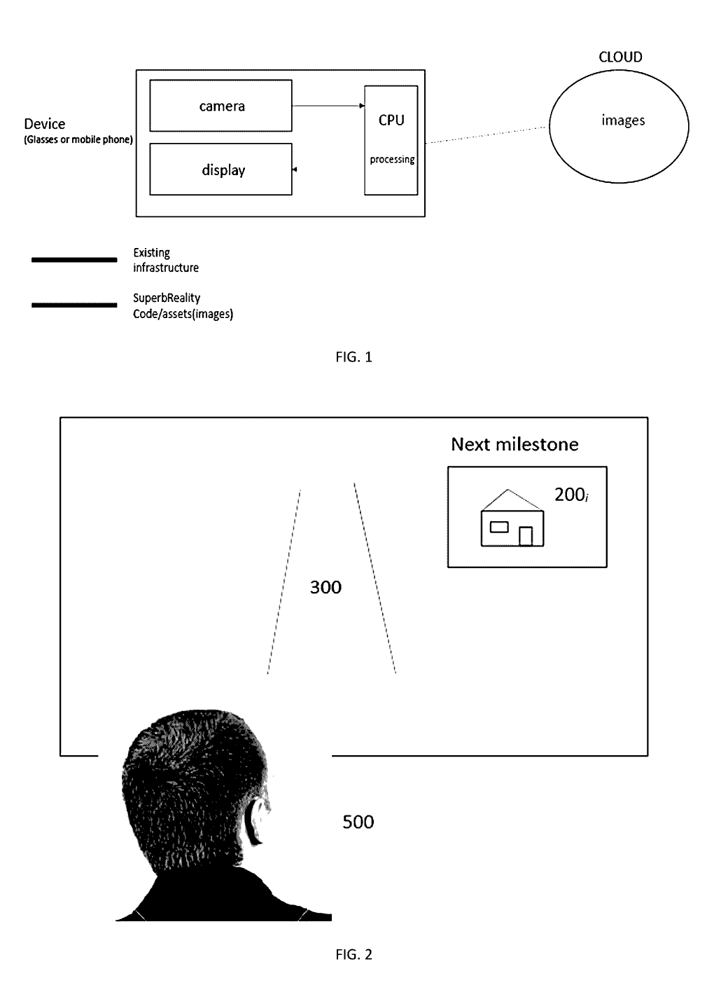

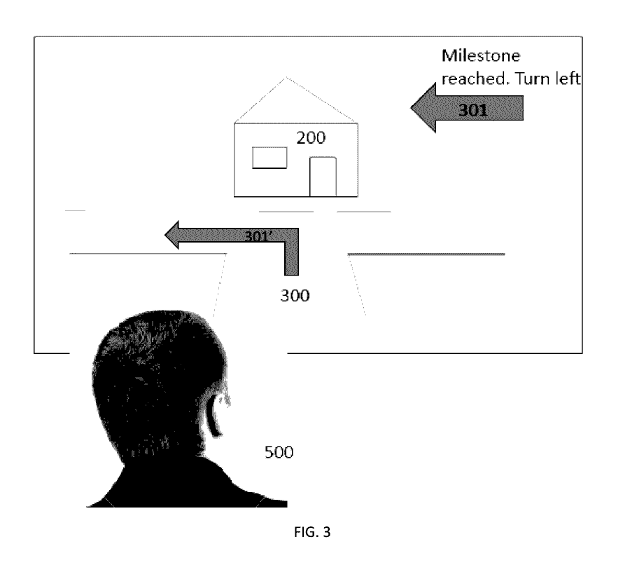

Typically, to navigate to a certain destination, the entire route, once calculated, is broken down into landmarks. Each landmark (See e.g., 200ᵢ, FIG. 2) can be chosen by a certain rules so it can well distinguished visually. While navigating, either by foot or by any vehicle, the systems and methods for using augmented reality display in providing object-based rout guidance and navigation can provide at least one landmark or object in the visual field of view (See e.g., FIG. 2, 3), on top of a real visual display, optionally accompanied by arrows (See e.g., 301, 301′, FIG. 3) or other landmark and/or destination indicia, (See e.g., 301, FIG. 3) displayed either on a display of a mobile device, or for example, wearable AR device(s) (e.g., glasses/lens), that may guide the user to the next visible landmark selected in the predetermined route direction.

Each displayed landmark can either be uploaded from an existing data base of landmarks that exist on the device or stored remotely (e.g., on a content management server—the cloud (See e.g., FIG. 1)). Alternatively, the subsequent landmark or object can be chosen automatically by a processor readable media in communication with non-volatile memory containing executable software in communication with an image capturing means, for example—a camera (See e.g., FIG. 1). The process of choosing automatic landmark can involve a software that determine, from a plurality of images received from the image capturing means (e.g., camera), what will be the optimized distinguishing visual landmark object from the image. The selection of the optimized landmark can depend in an embodiment on whether navigation is by foot or by a vehicle and which vehicle, the distance between the turns, time of navigation (day/night) or selection factors comprising one or more of the foregoing.

The images can be captured and either compared with images existing in the data base, or alternatively, compared against the optimized route guidance selected. This object/landmark can be a sub region of the entire image received from the image capturing means (e.g., camera), or the object/landmark can be the entire image itself. To increase the quality of the visual landmark, the software can deploy several quality enhancing methods such as temporal or spatial super resolution, time averaging and more. The automatic landmark detection can also include some logic that ensures that the image capturing means (e.g., camera) may be configured to be aligned with the route guidance (navigation).

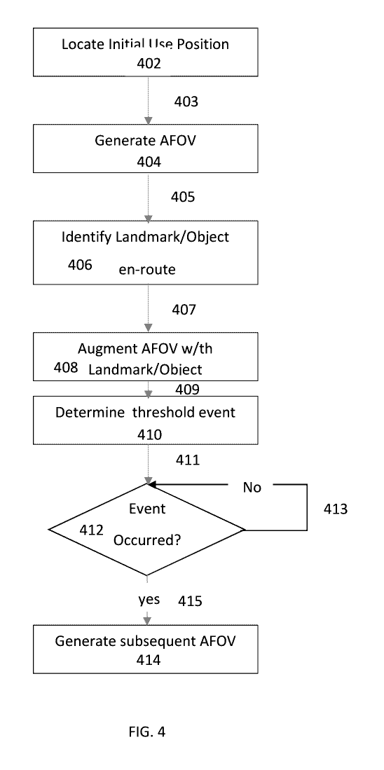

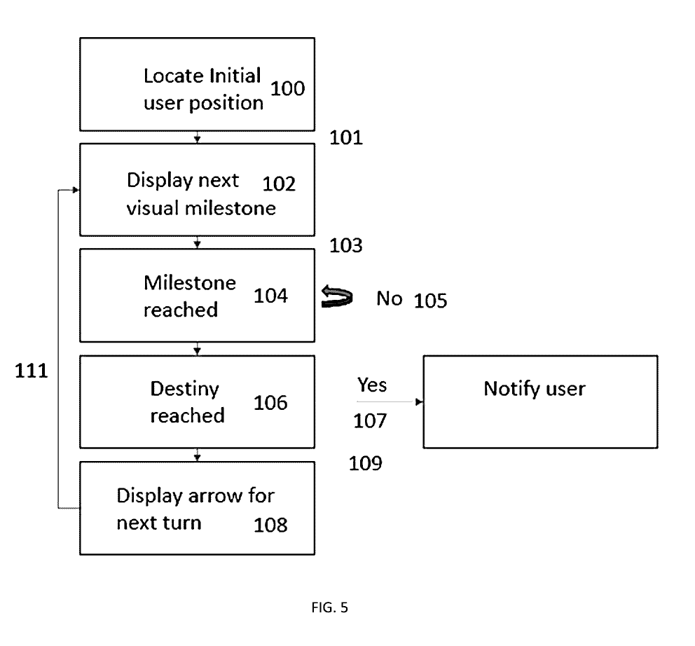

Accordingly and in an embodiment, provided herein is an augmented reality device configured to generate an augmented reality (AR) environment comprising an a physical field of view (RFOV) and augmented field of view (AFOV) (See e.g., FIG. 2), the augmented reality device comprising; a processor in communication with a non-volatile memory with a processor readable media thereon having a set of executable instructions configured to: locate initial user position (see e.g., 402, FIG. 4); generate the AFOV coincident with the RFOV of the initial user position (see e.g., 404, FIG. 4); recognize at least one object representative of a predetermined destination location occurring in the RFOV (see e.g., 406, FIG. 4); and augment the RFOV with the at least one object representative of the predetermined destination location occurring in the RFOV (see e.g., 408, FIG. 4), determine an event associated with the augmented reality environment (see e.g., 410, FIG. 4), and generate a subsequent augmented reality environment based on the determined event (see e.g., 412, 414, FIG. 4).

The term “communication” and its derivatives (e.g., “in communication”) may refer to a shared bus configured to allow communication between two or more devices, or to a point to point communication link configured to allow communication between only two (device) points. Likewise, the term “operatively coupled” or “operably coupled” refers to a connection between devices or portions thereof that enables operation in accordance with the present system. For example, an operative coupling may include one or more of a wired connection and/or a wireless connection between two or more devices that enables a one and/or two-way communication path between the devices or portions thereof. In addition, an operable coupling may include a communication path through a wired and/or wireless network, such as a connection utilizing the Internet. The term contact center is utilized herein to describe a support/service center and as such, may be a contact center, call center, etc.

The AR display, whether as part of a mobile device or the wearable device allows the system of the object-based rout guidance and navigation to overlay computer generated landmarks and/or objects over the user's current field of view of his surroundings, creating an scene (AFOV) comprised of the user's real world surroundings and augmenting computer generated landmarks/objects, thus, the term “augmented reality”.

The device(s) used in the systems and methods for using augmented reality display in providing object-based rout guidance and navigation, can further comprise an imaging module configured to image the entire RFOV, or a portion thereof and a global positioning system. The imaging module can be, for example, a charge-coupled array (CCD), and/or a complimentary metal oxide semiconductor (CMOS) array and the like. Moreover, as used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

Further, location data both for the client (user or vehicle comprising the AR (input) device can be gathered in real-time using Geo-positioning systems (GPS) located on the input device, or for each of the input devices may be any type of mobile electronic device having a display and wireless communication capability. These are, for example, cellular telephone handsets, personal digital assistants (PDAs), tablet computers, phablets and handheld gaming devices and the like. The location determination can be, for example when the vehicle is within a range of between about 1 m to about 500 m from a location determining device, for example, a short range communication device. Short-range communications are for example, Bluetooth®. (“BLUETOOTH® is a registered trademark of Bluetooth SIG”), WiFi® (“WI-FI® is a registered trademark of the Wi-fi alliance”), UWB, Zigbee® (“Zigbee® is a registered trademark of Zigbee alliance), whispering optical display, 3G and 4G other augmented sensor networks etc. The display devices can communicate with the main application server and each other through predetermined communications channels.

For example, global positioning (or geopositioning) system (GPS) refers to a space-based global navigation satellite system that can provide location and time (temporospatial) information at practically all times and for practically anywhere on the Earth when and where there is an unobstructed line of sight to four or more GPS satellites. Typically, a GPS receiver used in the systems and methods provided as part of the mobile input device (interchangeable herein with “AR device”) herein can calculate a position of the receiver by precisely timing the signals sent by the GPS satellites. Each satellite can then continually transmit messages that include such information as the time the message was transmitted, the precise orbital information for the satellite, and the general system health and rough orbits of all GPS satellites. The GPS receiver located for example on the application server, can then utilize the messages it receives to determine a transit time of each message independent of the end user and compute the distance to each satellite. These distances along with the satellites' locations are used to compute the position of the receiver and transmitter (transceiver) and be used to assess the progress among the various landmarks/objects, and also be used to load the next image.

The systems and methods for using augmented reality display in providing object-based rout guidance and navigation, can be adapted to: establish a dedicated communication network, (or use existing networks) robust enough to endure a large number of dislocated devices (e.g., cellular telephone handsets or smartphones, personal digital assistants (PDAs), tablet computers, phablets, laptops, handheld gaming devices, AR eyeglasses/lenses and the like) without overloading the network. The systems can also be adapted and configured for generating communication algorithm to send data packets (e.g., captured images, memory images, navigation guidance indicia (arrows) and the like) to the AR (input) devices in a fast and efficient manner. Also, the systems provided herein, used in conjunction with the methods described herein, can be configured to create a positioning system that will temporospatially pinpoint the dislocated AR input devices and/or vehicle(s).

In an embodiment, using a mapping application residing on the AR (input) device, end users located in the vicinity of a landmark/object identified in the system (either locally or remotely), can log on to a management server and synchronize with the system. The term “synchronized” refer for example, to the transfer of timing information and files or content (e.g., the real field of view in real time) so that input devices (and/or vehicles) are “synchronized” with respect to the information on the application server.

Further, the device(s) used in the systems and methods for using augmented reality display in providing object-based rout guidance and navigation, can also comprise a sensor configured to sense head movement of the user and/or a gyroscope configured to measure the device (in other words, the display or wearable device/lens) rotation in 3 axes, and/or an eye-tracking unit configured to track eye movement of the user. Accordingly, forward-looking imaging device and image capture application of the imaging module can detect objects in the real field of view of the user, and compare the captured images with images stored on the device memory itself, or remotely stored on an application content server in communication with the device. Alternatively, the imaging module can be configured to align the captured images with the optimized route selected by the user, and select those images/objects as the basis for guiding the user. In an embodiment, the term “eyeball tracker” refers to a device or module, whereby an individual's eye movements are measured so that the system knows both where the user is looking at any given time and the sequence in which their eyes are shifting from one location to another. Eyeball tracking techniques used in the systems and methods for using augmented reality display in providing object-based rout guidance and navigation can be, for example, Electra-Oculography, Limbus, Pupil and Eyelid Tracking, Contact Lens Method, Corneal and Pupil Reflection Relationship, Purkinje Image Tracking, Artificial Neural Networks, Head Movement Measurement or a technique comprising a combination of one or more of the foregoing.

As indicated, the image of the object representative of the predetermined destination location occurring in RFOV is preloaded onto the non-volatile memory and is configured to be generated in response to head movement and/or eye movement of the user and/or gyroscope read of the device. Representative object, can be an object or landmark that is best position to indicate to the user the guided route to the final destination. It should be noted that the term “non-volatile memory” is used to refer to means that code information in the memory will be retained in the memory unit even if electrical power is temporarily lost. Another type of useful non-volatile memory is the well known electronically programmable read only memory (EPROM), FLASH, a PROM, a FLASH-EPROM, an EEPROM, a flash memory, any other memory chip or cartridge that maintains information absent power.

As indicated, the image(s) of the objects and/or landmarks need not reside on the device itself, but rather is stored remotely. In other words, the image of the object representative of the predetermined destination location occurring in the RFOV is not preloaded and is captured by the imaging module and is configured to be captured in response to head movement and/or eye movement of a user and/or gyroscope read of the device and generated thereafter. The image can be configured to be within the user's field of view and can be updated at a rate commensurate with the rate of the user's progress along the guided route. Likewise, the image can be selected based on time of day (along the designated route).

In an embodiment, event associated with the augmented reality environment determined by the processor in the systems and methods for using augmented reality display in providing object-based rout guidance and navigation, can be, for example coincidence, or proximity, rate of progress, distance to next milestone, or a combination thereof; of the user location and the object representative of a predetermined destination location. In other words, once the system determines that the user has arrived at the image/object/landmark determined by the system as representative of the route guidance (see e.g., 411, FIG. 4), the system can determine that the predetermined event has occurred (see e.g., 415, FIG. 4), and upload the next (subsequent) representative image/landmark/object on top of the real field of view (see e.g., 414, FIG. 4), forming the next AFOV.

In an embodiment, the systems described herein are used in the methods described. Accordingly, provided herein is a method for navigating to a predetermined destination in a physical environment comprising: providing an augmented reality device configured to generate an augmented reality (AR) environment comprising an a physical field of view (RFOV) and augmented field of view (AFOV), the augmented reality device comprising; a processor in communication with a non-volatile memory with a processor readable media thereon having a set of executable instructions configured to: determine location of a user (See e.g., 500, FIG. 3); generate the AFOV coincident with the RFOV of the determined location; recognize at least one object representative of a predetermined destination location occurring in the RFOV and augment the RFOV with the at least one object representative of the predetermined destination location occurring in the RFOV, determine an event associated with the augmented reality environment, and generate a subsequent augmented reality environment based on the determined event; and moving towards the object representative of the predetermined destination location.

Further, the method for navigating to a predetermined destination in a physical environment, can also involve the steps of upon reaching the object representative of a predetermined destination location occurring in the physical field of vie following the step of moving, observing the RFOV; and moving towards the additional object, while optionally providing additional signals, for example, visual signal, audible signals or a combination thereof

As indicated, the systems and methods for using augmented reality display in providing object-based rout guidance and navigation, can further comprise a processor configured to facilitate the route guiding systems described. Accordingly, provided herein is a non-transitory computer or processor readable storage medium having stored thereon processor-executable software instructions configured to cause a processor to perform the operations associated with the method providing navigation guidance using input device(s) as described herein. These instructions can be, for example, to communicate to a back-end content (management) server the current location of the user, the captured field of view and the images of landmarks/objects identified therein.

The term “processor-readable medium” as used herein refers to any medium that participates in providing information to the processor, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, hard disk, magnetic tape, any other magnetic medium, a CD-ROM, CDRW, DVD, any other optical medium, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term processor-readable storage medium is used herein to refer to any computer-readable medium except transmission media.

The term “content server” refers to a back-end hardware and software product that is used to manage content.

In an embodiment, the (input) AR device can include a controller comprising a central processing unit (CPU) that is microprocessor-based. The controller can perform various functions including, for example, contacting the management server, the application server or both and communicating to the content server the location of the user's vehicle or the user themselves. The user interface used in the systems and methods described herein to facilitate the communication, may be one or a combination of different types of user interfaces depending upon the device. Many tablet computers include push-buttons or touch screens or both. Keyboards, styluses and other types of input devices. The user interface can be used to provide various inputs and responses to elements displayed on the input device. When the user interface is a touch screen or touch display, the screen display and the user interface may be one in the same. More than one user interface may be incorporated into the input device.

In an embodiment, the content server can further comprise a non-volatile memory having thereon a set of executable instructions configured to compare images received from the device RFOV; recognize the at least one object representative of a predetermined destination location occurring in the RFOV; compare the at least one object representative of a predetermined destination location occurring in the RFOV; determine agreement between the at least one object representative of a predetermined destination location occurring in the RFOV and image residing on the content server; and if aligned with the navigation direction, render the at least one object representative of a predetermined destination location occurring in the RFOV, creating AFOV of the destination location, based on the captured image. It should be noted that the term rendering is a term used in computer jargon by animators, audio-visual producers and in 3D design programs, and refers to the process of generating an image from a 3D model, a captured image, a set of image vectors or raster files and refers to the process of constructing an image from image data. The rendering process can occur completely in hardware, completely in software or a combination of both hardware and software.

A memory component can also be in communication with the controller on the AR device. The memory component may include different types of memory that store different types of data. The memory component may store operating software for the device, operating data, user settings, documents, images, additional augmentation indicia, and applications. The applications may perform various functions, including an application for communicating with the main application server and location determinators illustrated in FIG. 1 and obtaining data from the image module and the application server. The application may allow the input device(s) to communicate directly with the application server.

A web interface may be used for communicating with the application server and/or the AR's image module. The web interface may allow a connection to the local area network (e.g., LAN or WiLAN). The web interface may also allow communication through a wireless network such as a local area network, wide area network (WAN) or a dedicated mobile or cellular network.

An interface component of the portal (in other words, the home page of the web interface) accessed when using the systems for the methods described, can be configured to connect to and retrieve requested data (e.g., images) from a gateway application server (in other words, the database main server).

End-user dedicated and/or customized interfaces can be applications that provide the proper queries to access relevant data, provide access for uploading product or service data, upon obtaining permission in the form of, for example, a code or a token, accessing other user-specific data server(s), e.g., the application server and the like.

Likewise, a step of temporospatially locating the AR (input) device(s) and/or the vehicles within a discrete area (in other words, beginning point, an event point, or end point of the trip) can comprise the step of triangulating each device or vehicle using WiFi, Bluetooth, GPS, 3G, 4G, ZigBee, Near-Field Communication or a combination comprising the aforementioned platforms.

The term “triangulating” is used herein at a loose sense, for lack of better terminology. It does not necessarily have to imply collecting data from three linear vectors pointing into a hierarchical space and to a subregion or node located at an intersection point of the three linear vectors. Using built-in transceivers in the input device(s) (e.g., AR eyeglasses/lens), each of the AR (input) device(s) transceiver can record the beacons' IDs (for example, a cell tower), and determines the received signal strengths, of the beacon transmissions it detects. The received signal strength can establish a maximum plausible distance between the beacon and the input device(s) transceiver. Using the networked application residing on the AR device, the transceivers forward some or all of this information to the main content-management server or other processing node (in communication with the application server, e.g., the insurance provider's). The processing node (or main server) can then use this information, together with information about expected received signal strengths in specific landmarks/objects in the guided route path, to predict the current location (i.e. temporospatial location) of each transceiver ergo each input device(s). Other methods can use triangulation using similar methods but using 3G or 4G (or other) with a plurality (e.g., more than 3) cell towers distributed in the volume.

Further, the term “communication path” refers to a communication format that has multiple channels. For example, contemplated communication paths include radio frequency bands, including NOAA frequency band, EAS frequency band, various UHF and/or VHF frequency bands, microwave and infrared frequency bands, frequency bands used for cellular communication, cable and/or satellite TV transmission systems, optical network systems, and/or high-speed digital data transmission systems. The term “channel” can refer to a specific modality within the communication path. For example, where the communication path is cellular communication (e.g., 824-849 MHz, 869-894 MHz, or 1850-1990 MHz), the channel may be a single frequency, or a spectrum of multiple frequencies (e.g., CDMA signal) within that communication path. Likewise, where the communication path is a fiber optic cable system, channels will correspond to high-speed (e.g., >1.0 Mb/s) digital data transmission system, a channel may be a network address.

In an embodiment, the systems and methods for using augmented reality display in providing object-based rout guidance and navigation, can further comprise a load balancer in communication with a plurality of wide area network servers, web data servers, node data servers and the like; and the (plurality of) AR device(s). The load balancer can communicate as described herein over a large multi-node network, such as the dedicated WiLAN. The systems described herein, for implementing the methods provided herein, can further comprise an administrative client device and a business client device in communication with the main gateway application server. The term “server” refers for example to the process that provides the service, or the host computer on which the process operates. Similarly, the term “client”, or “client device” refers in another embodiment to the process or device that makes the request, or the host computer/device on which the process operates. As used herein, the terms “client” and “server” can refer to the processes, rather than the host computers, unless otherwise clear from the context. In addition, the process performed by a server can be broken up to run as multiple processes on multiple hosts for reasons that include reliability, scalability, security and redundancy, among others.

In addition, provided herein is a non-transitory computer readable storage medium having stored thereon processor-executable software instructions configured to cause a processor to perform the operations associated with the method of any of the steps described in the methods described hereinabove.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All ranges disclosed herein are inclusive of the endpoints, and the endpoints are independently combinable with each other. “Combination” is inclusive of blends, mixtures, alloys, reaction products, and the like. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the image(s) includes one or more image). Reference throughout the specification to “one embodiment”, “another embodiment”, “an embodiment”, and so forth, when present, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All ranges disclosed herein are inclusive of the endpoints, and the endpoints are independently combinable with each other. Furthermore, the terms “first,” “second,” and the like, herein do not denote any order, quantity, or importance, but rather are used to denote one element from another.

Likewise, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed:

1. An augmented reality device configured to generate an augmented reality (AR) environment comprising an a physical field of view (RFOV) and augmented field of view (AFOV), the augmented reality device comprising; a processor in communication with a non-volatile memory with a processor readable media thereon having a set of executable instructions configured to:
i. determine a user location;
ii. generate the AFOV coincident with the RFOV of the determined user location;
iii. recognize at least one object representative of a predetermined destination location occurring in the RFOV;
iv. augment the RFOV with the at least one object representative of the predetermined destination location occurring in the RFOV;
v. determine an event associated with the augmented reality environment; and
vi. generate a subsequent augmented reality environment based on the determined event.

2. The device of claim 1, wherein the device further comprises an imaging module configured to image the entire RFOV, or a portion thereof and a global positioning system.

3. The device of claim 2, further comprising a sensor configured to sense head movement of the user and/or a gyroscope configured to measure the device rotation in 3 axes, and/or an eye-tracking unit configured to track eye movement of the user.

4. The device of claim 3, wherein the image of the object representative of the predetermined destination location occurring in RFOV is preloaded onto the non-volatile memory and is configured to be generated in response to head movement and/or eye movement of the user and/or gyroscope read of the device

5. The device of claim 3, wherein the image of the object representative of the predetermined destination location occurring in the RFOV is not preloaded and is captured by the imaging module and is configured to be captured in response to head movement and/or eye movement of a user and/or gyroscope read of the device and generated thereafter.

6. The wearable device of claim 1, wherein the object representative of a predetermined destination location occurring in an environment related to the augmented reality device is configured to be within the user's field of view.

7. The device of claim 1, wherein the event associated with the augmented reality environment determined by the processor is coincidence of the user location and the object representative of a predetermined destination location.

8. The device of claim 1, wherein the augmented reality device is a mobile communication device, eyeglasses, or a contact lens.

9. A method for navigating to a predetermined destination in a physical environment comprising:
a. providing an augmented reality device configured to generate an augmented reality (AR) environment comprising an a physical field of view (RFOV) and augmented field of view (AFOV), the augmented reality device comprising; a processor in communication with a non-volatile memory with a processor readable media thereon having a set of executable instructions configured to:
i. determine location of a user;
ii. generate the AFOV coincident with the RFOV of the determined user location;
iii. recognize at least one object representative of a predetermined destination location occurring in the RFOV;
iv. augment the RFOV with the at least one object representative of the predetermined destination location occurring in the RFOV;
v. determine an event associated with the augmented reality environment; and
vi. generate a subsequent augmented reality environment based on the determined event; and
b. moving towards the object representative of the predetermined destination location.

10. The method of claim 9, wherein the augmented reality device further comprises an imaging module configured to image the RFOV and a global positioning system (GPS).

11. The method of claim 10, wherein the device further comprises a sensor configured to sense head movement of the user, and an eye-tracking unit configured to track eye movement of the user.

12. The method of claim 11, wherein the object representative of a predetermined destination location occurring in an environment related to the augmented reality device is configured to be within the user's field of view.

13. The method of claim 12, wherein the image of the object representative of the predetermined destination location occurring in RFOV is preloaded onto the non-volatile memory and is configured to be generated in response to head movement and/or eye movement of the user.

14. The method of claim 12, wherein the image of the object representative of the predetermined destination location occurring in the RFOV is not preloaded and is captured by the imaging module and is configured to be captured in response to head movement and/or eye movement of the user and generated thereafter.

15. The method of claim 14, wherein the processor of the augmented reality device is configured to compare the image captured in response to head movement and/or eye movement of the user, with images remotely stored on a content management server or images located on the device memory before the step of generating subsequent image.

16. The method of claim 12, wherein the event associated with the augmented reality environment determined by the processor is coincidence of the user location and the object representative of a predetermined destination location.

17. The method of claim 16, wherein the device processor is configured to generate an additional object representative of the predetermined destination location occurring in the physical environment.

18. The method of claim 17, further comprising the step of:
a. upon reaching the object representative of a predetermined destination location occurring in the physical field of vie following the step of moving, observing the RFOV; and
b. moving towards the additional object.

19. The method of claim 18, wherein the device further comprises simultaneously providing additional signals in the AFOV.

20. The method of claim 19, wherein the additional signals are visual signal, audible signals or a combination thereof.

21. The method of claim 9, wherein the device is eyeglasses.

22. A system for providing object-based navigation guidance comprising: the AR device of claim 1; and a content server.

23. The system of claim 22, wherein the content management server comprises a non-volatile memory having thereon a set of executable instructions configured to compare images received from the device RFOV; recognize the at least one object representative of a predetermined destination location occurring in the RFOV; compare the at least one object representative of a predetermined destination location occurring in the RFOV; determine agreement between the at least one object representative of a predetermined destination location occurring in the RFOV and image residing on the content server; and if aligned with the navigation direction, render the at least one object representative of a predetermined destination location occurring in the RFOV, creating AFOV.
